(19) United States
(12) Patent Application Publication
(10) Pub. No.: US 2023/0065669 A1
(43) Pub. Date: Mar. 2, 2023

(54) Cellular Backup Contact (CBC)

(71) Applicant: Edmond Chenet, JR., Hialeah, FL (US)

(72) Inventor: Edmond Chenet, JR., Hialeah, FL (US)

(21) Appl. No.: 17/412,214

(22) Filed: Aug. 25, 2021

(51) Int. Cl. H04M 1/27453; G06F 11/14

(52) U.S. Cl. CPC H04M 1/27453; G06F 11/1448

(57) ABSTRACT

Following is an overview of the infrastructure architecture for the CBC and associated services, based on our stack. The platform has been developed using primarily Jitsi. Our efforts have been to combine these systems and to make them user friendly and specific for contacts storing and making internet calls.

CBC (Cellular Backup Contact) is a mobile/web application that provides “Instant Access” to your contacts, with and without your mobile phone anywhere in the world or any other devices using an internet connection like Laptop/iPad or a telephone system (IVR). The app will automatically backup your contacts after completing the registration and constantly update the initial contact changes from the mobile phone. The mobile/web application allows the users to send SMS/call/video/conference calls and video conference calls by using the contact lists.

a. How it Works:

The CBC application does not require any configuration to access your contacts to other mobile phones to call/video/conference and send SMS. CBC backups your contacts and can be restored anytime, on any device as required. CBC provides a combined solution to transfer all your contacts from any android/iPhone device to another iPhone/Android device. Make calls to your offline friend using ‘application to mobile’ call feature. Chat with your contacts as needed by sharing your files at flicks of a switch.

CBC application has a “Restore Access” to restore the contacts, a “Backup Access” to initialize the automatic backup after upgrading to new version hardware, and a search access to search by names or by area code.

b. Features:

The key features of the application are described below:

a. Backup Contacts
b. Restore contacts
c. App to App/App to mobile call

i. Audio call

ii. Video call

iii. Conference Calls

iv. Conference Video Calls

d. Call Logs
e. Chats

c. Call & Chat:

Enjoy free voice calls on CBC for both application to application and application to mobile calls and discover many features to help you stay connected with the people in your contact list. The application has the capability to show the entire calls log from your original mobile phone (Missed/Received/Dialed). CBC brings conversations to life by reacting to any message and expressing yourself with GIFs, stickers and shares any type of file.

d. Contact Access:

CBC app users can access their contacts through the following ways
Admin-web page
User-mobile application
Phone access by using IVR (Interactive Voice Response)

### REQUIREMENTS

### Phases:

The phases are depicted below:
Admin-Web page
User-Mobile application
Phone access by using IVR (Interactive Voice Response)

### Admin-Webpages:

The admin-webpages have the following items:
Website design.
Features of CBC
Application download Link
   Contact and FAQ

### User-Mobile Application:

The mobile application has several features which have been described above and to register to the application, the users have to fill up the user register form which contains the following:
User registration
   First name(mandatory)
   Last name(optional)
   Mobile number(mandatory)—validation
   Alternate mobile number(optional)
   Email id (Mandatory)
   Username (Mandatory)—Validation (Primary key)
   Password (Mandatory)
   Confirm password (min 8 characters—alphabets—1capital & 1-small letter, numerical and special character).
Security questions—1/9 questions.
   Login form:

The login form has the following fields
Username/Email id
Password
Active/inactive validation If inactive contact admin-chat

### Homepage:

The homepage contains the following below items:
Contact list
App to App call
App to phone call
App to App message
App to phone message
Call logs
Conference Calls
Video & Conference calls
Top right corner
Restore Contacts list

### Phone Access:

Using IVR (Interactive Voice Response)”

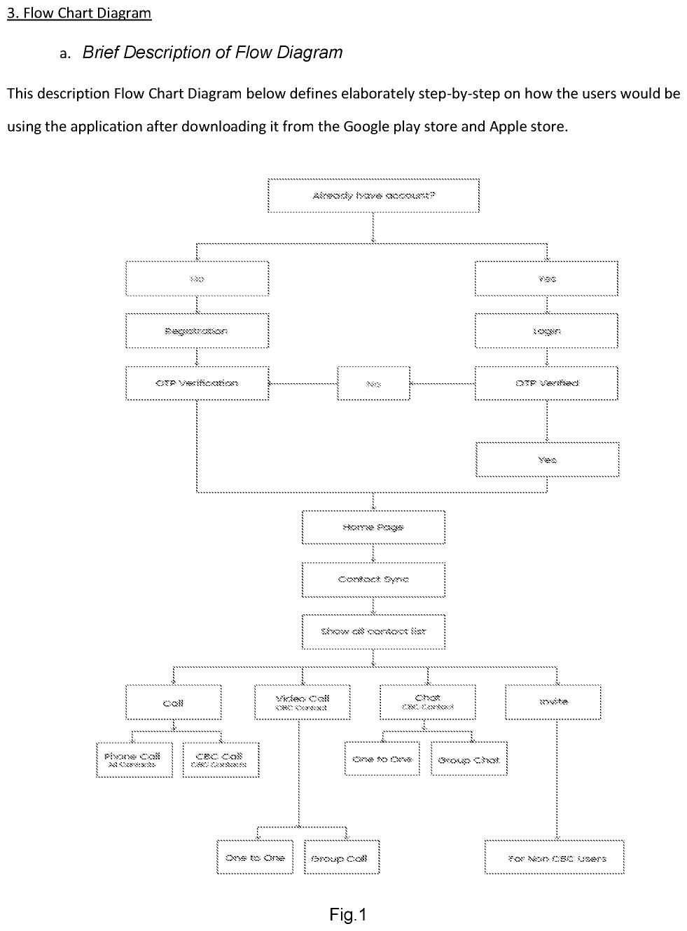

### BRIEF DESCRIPTION OF THE DRAWING FIG. 1

The Brief description of the drawing defines elaborately step-by-step on how the users would be using the application after downloading it from the Google play store and Apple store. The other features of the app are also discussed in detail below including homepage features, creating groups, editing profile beside others.

### A. DESCRIPTION

Already have account: By downloading the app, If the user has an account, user will sign it. If not, User would create an account. (100)
No: “No” indicated the user has not created an account yet to access the CBC App. (101)
Yes: “Yes” indicates the User has already created an account. (102)
Registration: Users will register into the application with their username, phone number, email address, first name, last name, password, and security question. An OTP (One Time Password) will be sent to their phone number/email address. After successful verification of the OTP users will be allowed to use the application and they will be redirected to the dashboard. If the OTP is not verified, then they would not be allowed to login to the application. (103)
Login: Users can put their username and password to log into the application. After successful login, the application will redirect the user to the dashboard. If user skips the security question validation during login, then automatic sync of contacts will not work for that device, otherwise automatic sync will work. If OTP is not verified, then user must verify the OTP first then they will be proceeded to the dashboard. (104)
OTP Verification: An OTP (One Time Password) will be sent to their phone number/email address. After successful verification of the OTP users will be allowed to use the application and they will redirect to the dashboard. If the OTP is not verified, then they would not be allowed to login to the application. (105)
No: Indicate the application cannot validate the OTP (One Time Password). (106)
OTP Verified: After login, If the OTP is not verified. then they would not be allowed to login to the application. (107)
Yes: After OTP Verification, the app would take the user to the Homepage. (108)

### Homepage:

The homepage contains the following items:
1. Contacts—It will show all the sync and backup phone numbers.
2. My Message—It will show the list of contacts or groups with their last sent messages.
3. Call logs—It is showing the recent call logs (audio and video). Users can initiate call from there as well.
4. Search—Search will work for the above 3 menus to quickly find the desired item.
5. Side Menu—A general menu consists of some profile, settings related stuff.
6. 3 dot menu—The Dot menu on the top right corner gives you options for importing backed up contacts to the original device.
7. Block/Unblock user—Registered user can block users from calling them through the app or sending the messages. Registered user can unblock for the same.
8. Create Group—Use this button to get the group creation page.
9. Edit Profile, Change Password, Change Mobile & Delete Account
   Users can update some of their profile information in this section.
   Changing the login password can be done.
   Registered Users can change their registered mobile number by answering the security question.
   Security question is being taken during the registration process.
   Registered Users can delete their account from the CBC application. They will no longer be able
   to login to the application again.
10. CMS Contents, FAQ & Logout
   Registered Users can contact to the CBC app admin through Contact Us form.
   Registered Users will be able to see Terms & Privacy Policy, App Info etc.
   Logout can be done using the logout button of the side menu.
   Contact sync and other automatic backup functionalities will not work for that device if the user is logged out.
11. Create Group
   Registered users can create group with other users by providing group name, group image and group members information. Later they can chat with each other with the group. Group audio and video call features are there. (109)
   Contact Sync: The app will sync all the new, editing contacts from the original phone. (110)
   Show all contacts list: The app will display the full contacts lists for the registered user. (111)
   Call: Registered user will be able to make call from app to app and app to Mobile. (112)
   Phone call all contacts: Registered user will be able to call from all the contacts by having the option App to Mobile. (116)
   CBC Call CBC contact: Registered user will be to call from App to app by using the app. (117)
   Video Call CBC Contact: Registered user will access to make a video call from one to one or group video call to any other register users. (113)
   One to One: Registered user would be able to make a video call from one registered user to another. (120)
   Group Call: Registered user would be able to make a Group video Calls with more than 200 hundred CBC registers User. Both audio and video group calls are supported. (121)
   Chat CBC Contact: Registered user would be able to send text messages, audio, video, image etc. using this feature. (114)
   One to one: Registered CBC user has the flexibility to chat one to one with other register CBC user. (118)
   Group Chat: Registered user also has the flexibility to Group Chat over 200 hundred registered CBC user. (119)
   Invite: Registered CBC ser can invite other registered CBC users to the Registered CBC app via Invitation. (115)
   For Non-CBC Users: Registered user can also invite a non-registered CBC users by using any other platforms like WhatsApp, Skype, Messengers including emails. (122)

1. CBC application has been developed to cater the needs of people for restoring their contacts once they lose their phone due to some instances. By login to our application or the website they would be able to retrieve all their lost contacts again.

2. A user using one type of device and subscribing to a communication server provider can exchange messages with users using other types of devices and subscribing to other communication service providers. Individual messages can be sent to any number of recipients, and a form of group communication (e.g. chat) is provided in which multiple users interactively exchange instant messages. They can send emojis or images or audio and video files.

3. We are also providing the users to call each and also initiate a group call through our CBC applications. They can add multiple people in the call and share their screen within the call.
